(19) United States
(12) Patent Application Publication
(10) Pub. No.: US 2016/0152102 A1
(43) Pub. Date: Jun. 2, 2016

(54) ROBOTIC TYRE CHANGING APPARATUS AND ASSOCIATED HARDWARE AND METHODS

(71) Applicant: MACHNERY AUTOMATION & ROBOTICS PTY LTD, Hornsby, New South Wales (AU)

(72) Inventor: Clyde CAMPBELL, Silverwater, NSW (AU)

(21) Appl. No.: 14/904,251

(22) PCT Filed: Jun. 19, 2014
(86) PCT No.: PCT/AU2014/000633

§ 371 Date: Jan. 11, 2016

(30) Foreign Application Priority Data
Jul. 12, 2013 (AU) 2013902573

(51) Int. Cl. B60C 25/05; B23P 19/08; B60B 30/02; B23P 19/04; B60C 25/132; B60B 29/00

(52) U.S. Cl. CPC B60C 25/0515; B60C 25/132; B60C 25/0521; B60B 29/001; B60B 30/02; B23P 19/047; B23P 19/084; B60B 2320/10; B60B 2320/50; B60B 2340/32; B60B 2340/50

(57) ABSTRACT

A tyre changing apparatus 1, for use with tyres on large haul trucks employed in mining operations. The apparatus includes a tyre handler. The grab unit of the tyre handler can provide a stable work platform from which robots may execute tasks. Hence, a first robot is disposed adjacent to the proximal end of arm and a second robot is disposed adjacent to the proximal end of the second arm. This apparatus may be utilised by the robots so as to spread the gap in a lock ring to assist when removing and installing the lock ring. An o-ring installation device may be utilized by the robots when installing an o-ring.

### FIELD OF THE INVENTION

The present invention relates to a robotic tyre changing apparatus and associated hardware and methods. Embodiments of the present invention find application, though not exclusively, in the mining industry for use with the wheels and tyres of large haul trucks and dump trucks.

### BACKGROUND OF THE INVENTION

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The removal of wheels and tyres from large mining haul trucks and dump trucks is typically achieved with the use of a mechanical wheel handler to support the wheel whilst a worker removes nuts to free the wheel from the hub. Typically this involves the worker operating hand tools or mechanised nut runners (such as pneumatic impact drivers, or the like) to loosen and remove each of the nuts whilst working within a region that is unsafe due to a risk that the tyre may fall or explode.

A partial solution to this problem is provided by the prior art arrangement disclosed in International Publication No. WO 2012/094706, which utilises a movable vehicle 42 working in conjunction with a tyre handler (as illustrated, for example, in FIGS. 16 to 18 of WO 2012/094706). A robotic arm 43 is mounted upon the movable vehicle 42, which is used to manipulate a nut runner 61. The “tyre handlers” in WO 2012/094706 are referred to as “wheel handlers”; however it is understood by the applicant that “tyre handler” is the generally accepted nomenclature within the mining industry. Accordingly, “tyre handler” shall be the term as used in this patent specification.

If it is desired to remove only a tyre (as opposed to the wheel and tyre together as discussed in the preceding two paragraphs), the tyre is firstly deflated and then a tyre handler is typically used to push the side wall of the tyre inwardly so as to reveal hardware referred to as “jewelry”, that is used to connect the tyre bead to the rim of the wheel. The jewelry typically includes a circular clip, referred to as a “lock ring”, which seats within a circumferential groove that extends around the wheel rim. The lock ring is removed from the wheel rim manually by a worker using a crow bar; with the worker being required to briskly evacuate from the area next to the wheel once the lock ring has been loosened and falls to the ground. Due to the size and weight of the lock ring, this poses a substantial risk of injury. An additional component of the jewelry is an o-ring, which also seats within a circumferential groove that extends around the wheel rim. Such o-rings are typically manually removed and subsequently inserted by a worker and this manual process exposes the worker to a risk of crushing or exposure to an explosion.

### SUMMARY OF THE INVENTION

It is an object of the present invention to overcome, or substantially ameliorate, one or more of the disadvantages of the prior art, or to provide a useful alternative.

In one aspect of the present invention there is provided a tyre changing apparatus for use with a tyre disposed on a wheel, said apparatus including:

a tyre handler having two arms respectively defining distal ends adapted in use to clampingly engage the tyre; and

at least one robot disposed on said tyre handler, the at least one robot being positioned for interaction with the wheel when the tyre is clampingly engaged by said distal ends.

Preferably the two arms define respective proximal ends that are each disposed on a frame and the at least one robot is disposed at, or adjacent to, at least one of the proximal ends. In one embodiment a first robot is disposed at, or adjacent to, the proximal end of a first of the two arms and a second robot is disposed at, or adjacent to, the proximal end of a second of the two arms.

Preferably the at least one robot is a robotic arm having a proximal end disposed on said tyre handler and having a distal end from which a tool is operable. In one embodiment the tool is at least one of: a nut runner; a lock ring gap spreader, an o-ring installation device, a cleaning device, an inflation device or a deflation device.

According to a second aspect of the present invention there is provided a lock ring gap spreader for use with a lock ring defining a gap, the lock ring gap spreader including:

a circular housing sized for fitment around the lock ring; and

an automated spreader unit disposed on a periphery of the housing, the automated spreader unit acting upon a pair of projections so as to define a closed state in which the pair of projections are disposed close enough to each other so as to fit within the gap and said spreader unit defining an open state in which the pair of projections are circumferentially spaced from each other so as to spread the gap in the lock ring.

In one embodiment the automated spreader unit is hydraulic and in another embodiment it is pneumatic.

The lock ring gap spreader preferably further includes a plurality of handles disposed on the periphery of the housing, each of the handles being engagable by a robotic arm.

Preferably the circular housing is sized so as to receive the lock ring whilst the gap in the lock ring is being maintained in a spread apart state by the spreader unit to thereby stablise the lock ring against twisting.

According to a third aspect of the present invention there is provided an o-ring installation device for installing an o-ring onto a slot in a wheel rim, the o-ring installation device including:

a circular ledge sized for fitment around the wheel rim and being sized so as to retain the o-ring upon the ledge by frictional engagement of the o-ring with the ledge; and

an actuator disposed on a periphery of the ledge and being operable to displace the o-ring off the ledge such that, in use, the o-ring radially contracts onto the slot in the wheel rim.

In one embodiment of the o-ring installation device the actuator is an electromagnetic linear actuator. Preferably the actuator acts upon an elongate member disposed at an angle of between 45° and 135° with respect to the ledge.

Preferably the o-ring is installable so as to resiliently radially bear upon the ledge and so as to rest against the elongate member.

According to a fourth aspect of the present invention there is provided a method of removing a wheel from a truck including the steps of:

providing a tyre changing apparatus as described above;

using the tyre handler to clampingly engage a tyre on the wheel;

causing the robot to operate a nut runner so as to remove nuts holding the wheel onto the truck; and

using the tyre handler to remove the wheel from the truck.

According to a fifth aspect of the present invention there is provided a method of removing a lock ring from a slot in a wheel rim, the method including the steps of:

providing a tyre changing apparatus as described above;

using the tyre handler to displace a bead of the tyre away from the lock ring installed on the wheel;

causing the robot to operate a lock ring gap spreader as described above so as to remove the lock ring.

According to a sixth aspect of the present invention there is provided a method of installing a lock ring onto a slot in a wheel rim, the method including the steps of:

causing a robot to operate a lock ring gap spreader as described above in the closed state so as to position the pair of projections within a gap in the lock ring;

toggling the lock ring gap spreader into the open state so as to spread the gap and so as to house the lock ring within the housing;

causing the robot to position the lock ring gap spreader such that the housed lock ring is radially aligned with the slot; and

toggling the lock ring gap spreader into the closed state so as to install the lock ring onto the slot.

According to another aspect of the present invention there is provided a method of installing an o-ring onto a slot provided within a rim of a wheel, the method including the steps of:

providing a tyre changing apparatus as described above; and

causing the robot to operate an o-ring installation device as described above so as to install the o-ring.

The features and advantages of the present invention will become further apparent from the following detailed description of preferred embodiments, provided by way of example only, together with the accompanying drawings.

### BRIEF DESCRIPTION OF THE ACCOMPANYING DRAWINGS

FIG. 1 is a side view of an embodiment of the tyre changer;

FIG. 2 is a front view of the tyre changer;

FIG. 3 is a plan view of the tyre changer;

FIG. 4 is a perspective view of the tyre changer;

FIGS. 5 to 13 are depictions of steps in an embodiment of a method of removing a lock ring from a slot in a wheel rim;

FIG. 14 is a front view of a first embodiment of a lock ring gap spreader in the closed state;

FIG. 15 is a partial front view of the first embodiment of the lock ring gap spreader in the closed state;

FIG. 16 is a front view of the first embodiment of the lock ring gap spreader in the open state;

FIG. 17 is a partial front view of the first embodiment of the lock ring gap spreader in the open state;

FIG. 18 is a front view of a second embodiment of a lock ring gap spreader in the closed state;

FIG. 19 is a front view of the second embodiment of the lock ring gap spreader in the open state;

FIG. 20 is a cross sectional view of a first embodiment of an o-ring installation device;

FIG. 21 is a cross sectional view of a second embodiment of an o-ring installation device;

FIGS. 22 to 25 are depictions of steps in an embodiment of a method of removing a lock ring from a slot in a wheel rim;

FIG. 26 is a schematic depiction of a wheel rim and associated jewelry; and

FIG. 27 is a cross sectional depiction of a dual rear wheel assembly.

### DETAILED DESCRIPTION OF PREFERRED EMBODIMENTS OF THE INVENTION

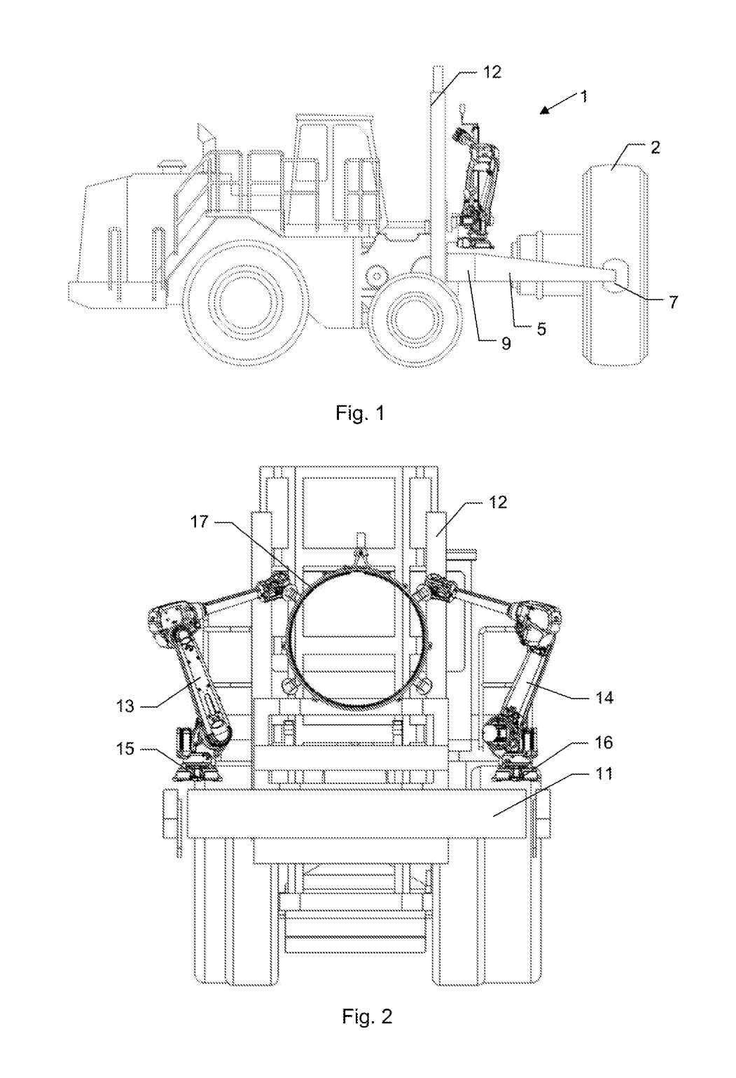

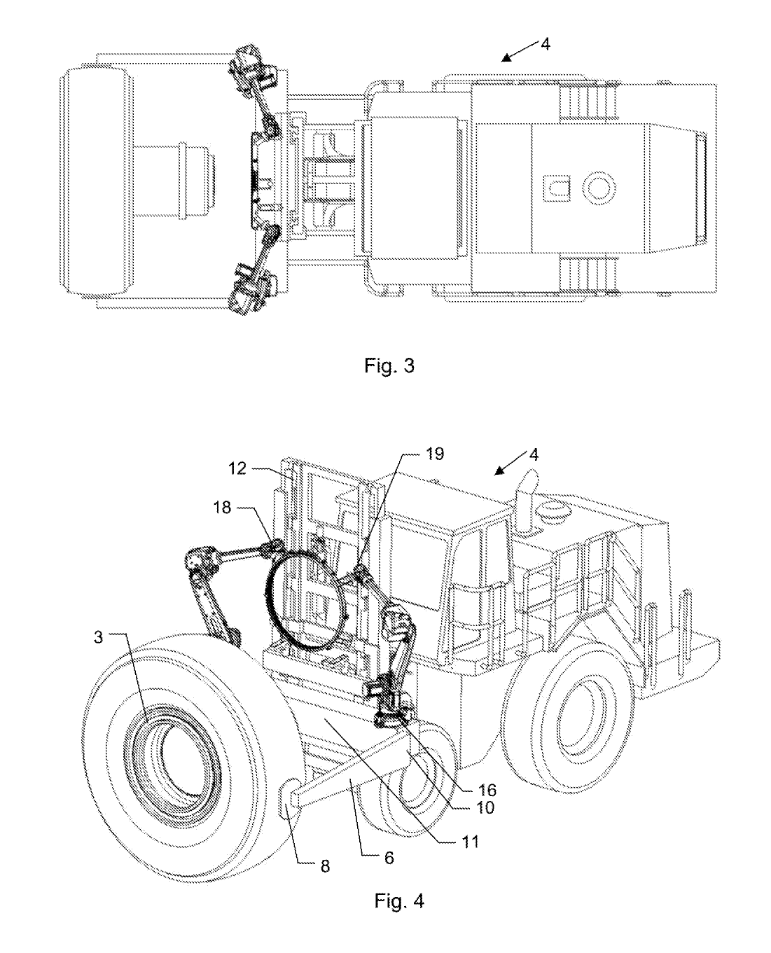

The embodiment of the tyre changing apparatus 1 as depicted for example in FIGS. 1 to 4 is for use with a tyre 2 disposed on a wheel 3 of the type commonly used for large haul trucks and in particular those typically employed in mining operations. The apparatus 1 includes a tyre handler 4, which may be any one of the various commercially available tyre handlers on the market, such as those marketed for example by: Iowa Mold Tooling Co. Inc, which is based in Garner, Iowa, USA; or Austin Engineering Ltd, which is based in Brisbane, Queensland, Australia; or Cascade Europe, which is based in El Amere, Netherlands. Such tyre handlers 4 are typically fork lift-type trucks that support two outwardly extending generally parallel arms 5 and 6, which respectively define distal ends 7 and 8. The operator of the tyre handler can manipulate the controls to cause the distal ends 7 and 8 of the arms 5 and 6 to clamp onto the tyre 2, which allows for manipulation of the large and heavy tyre and wheel.

The proximal ends 9 and 10 of arms 5 and 6 are each disposed on a cross member 11 to form a frame that is referred to as a “grab unit”. The frame (5, 6, 11) is disposed on a generally vertical track system 12 to allow the operator to raise and lower the frame as required. Additionally, in many embodiments of tyre handler, the distal ends 7 and 8 are rotatably mounted to the arms 5 and 6 to allow the operator to rotate the tyre and wheel, if necessary.

It has been appreciated by the inventor of the present application that the grab unit of a tyre handler can provide a stable work platform from which robots may execute tasks. Hence, a first robot 13 is disposed adjacent to the proximal end 9 of arm 5 and a second robot 14 is disposed adjacent to the proximal end 10 of the second arm 6. The illustrated preferred embodiment utilized two robots 13 and 14 so as to share the workload to increase the total operational speed. However, for applications in which operational speed is of a lesser importance, a single robot may be disposed on the frame (5, 6, 11). Additionally, if operational speed is of the essence, then more than two robots may be utilized. A robot control system is housed within a stainless steel enclosure that is disposed upon the tyre handler 4.

Each of the robots 13 and 14 is a robotic arm such as one of the IRB 4600 series of articulated robot, as marketed by ABB AB Robotics Products, which is based in Vasteras, Sweden. The particular robot utilized in the preferred embodiment is the IRB 4600-40/2.55. However, it will be appreciated that various other robots may be utilized in alternative embodiments.

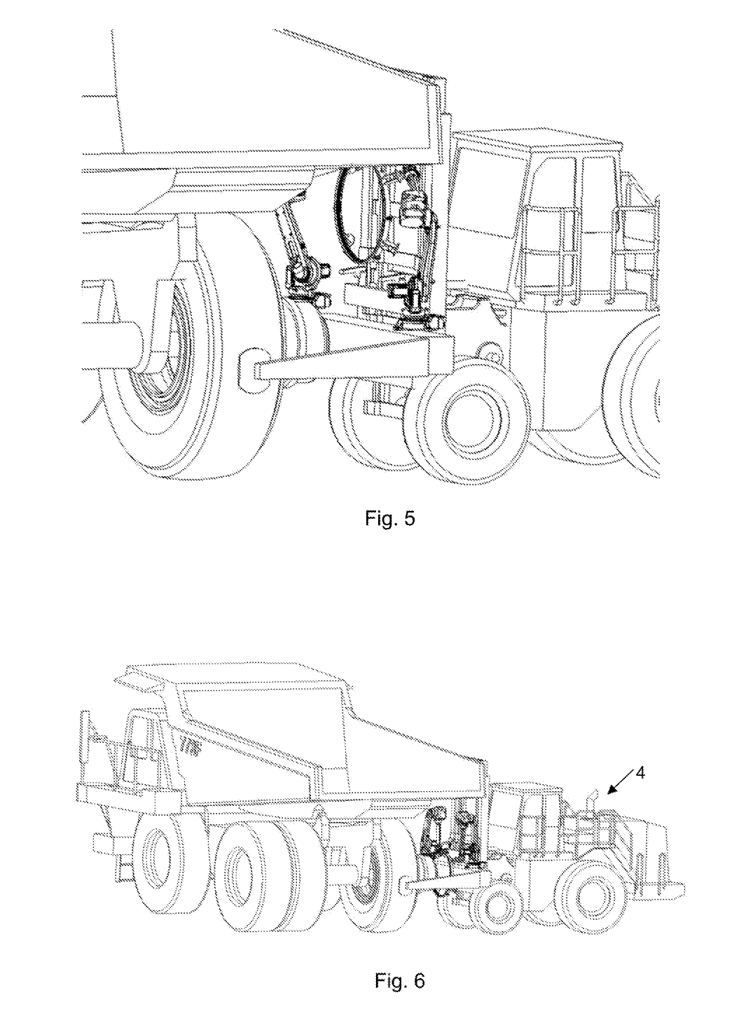

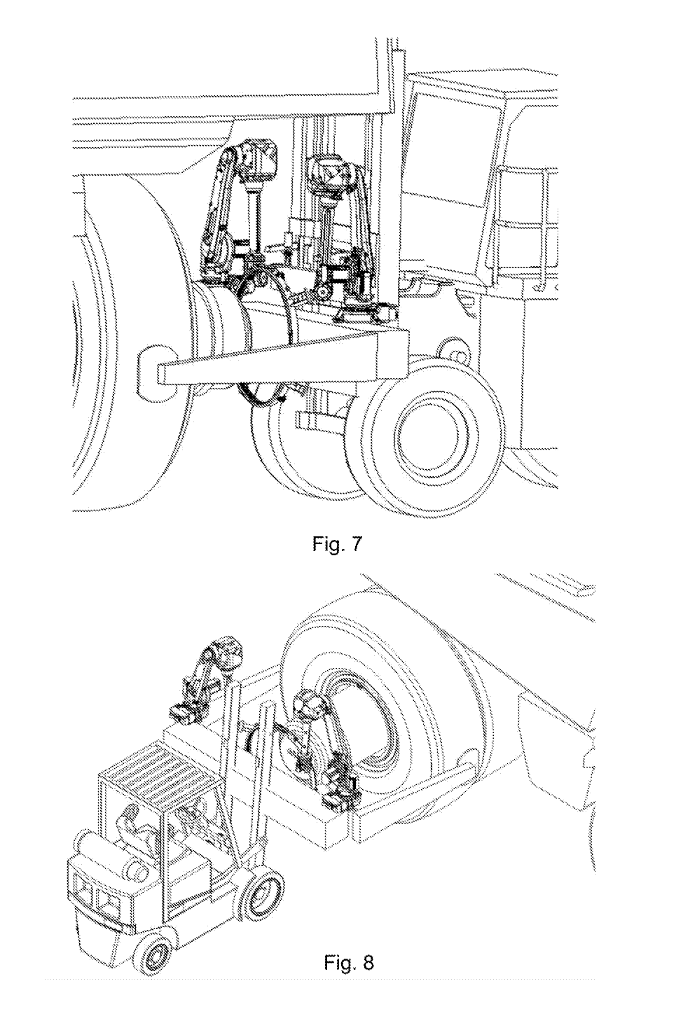

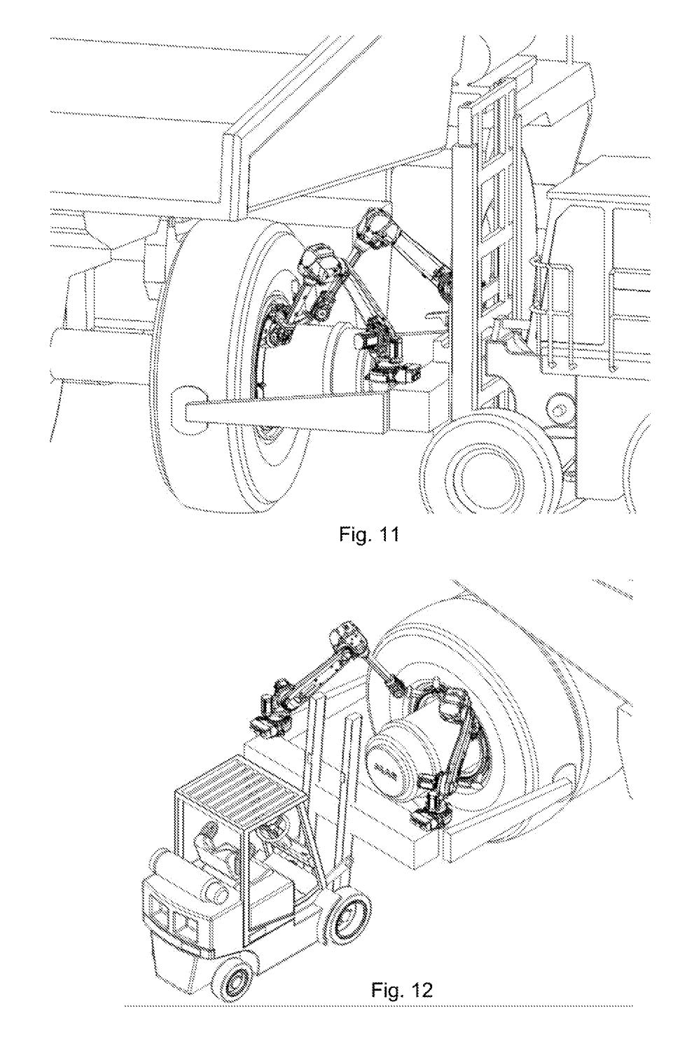

The proximal ends 15 and 16 of the two robots 13 and 14 are disposed on a base plate that is bolted or otherwise connected to the frame (5, 6, 11) of the tyre handler 4. The distal ends 18 and 19 of the two robots 13 and 14 each include a tool changer unit that is capable of automatically engaging with, and operating, a selected tool. The tool changer unit includes a plug for establishing electrical connections between the robot and the selected tool, along with hydraulic and pneumatic connections, as required. This allows the robot to control the operation of the selected tool. By way of non-limiting example, as shown in FIGS. 1 to 13, both of the robots 13 and 14 are operating a first embodiment of a lock ring gap spreader 20, which will be described below in further detail.

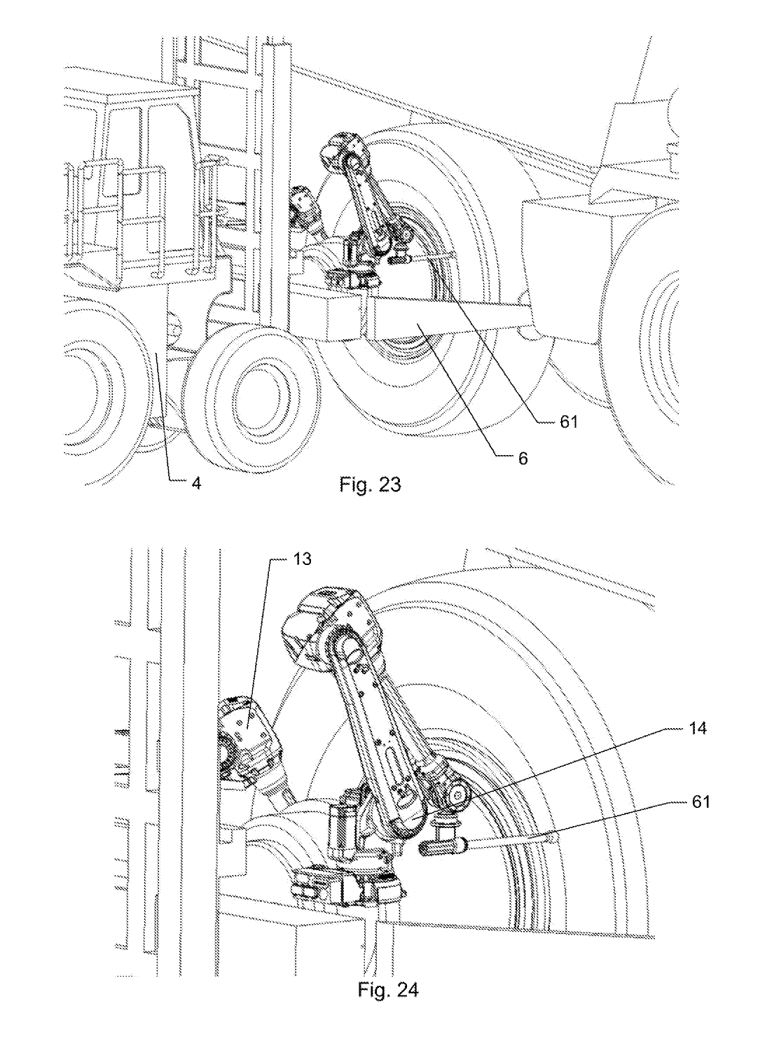

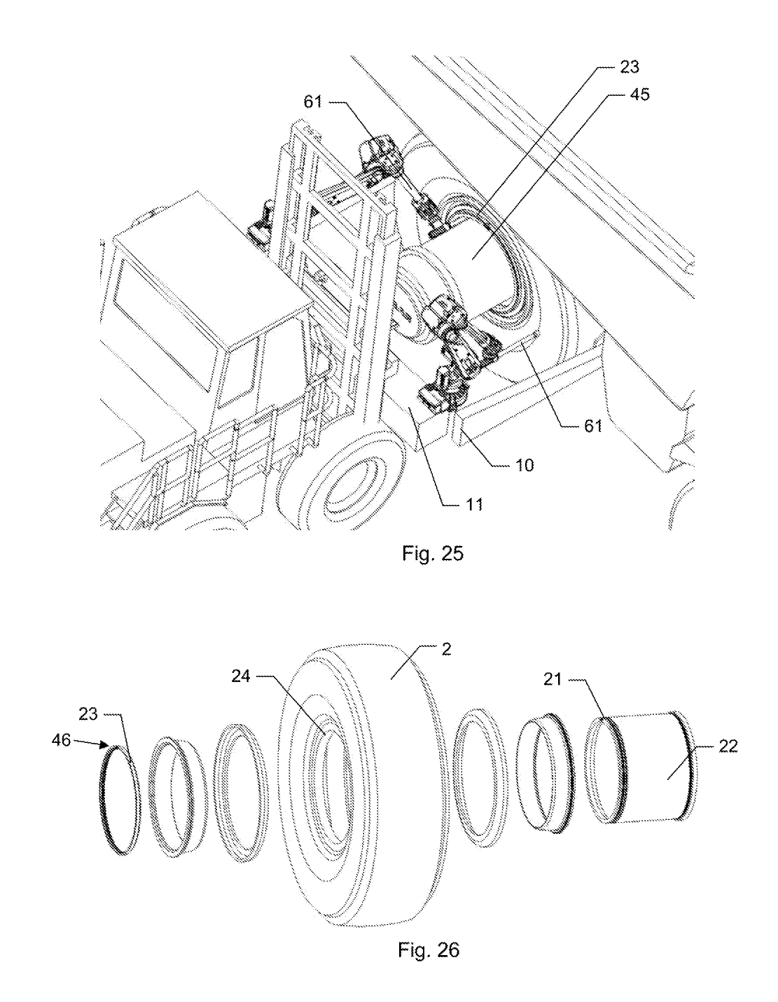

A non-limiting example of a plurality of tools being separately operated at the distal ends 18 and 19 of each the robots 13 and 14 is depicted in FIGS. 22 to 25, in which each of the robots 13 and 14 is operating a nut runner 61 in the form of an Acradyne Fixtured Type AEF Series torque tool having an approximate torque rating of 2500 Nm, as marketed by AIMCO Corporation, which is based in Portland, Oreg., USA. The wheel removal process commences with the step of using the tyre handler 4 to clampingly engage the tyre 2 on the wheel 3 that is to be removed. The robot control system then instructs one or both of the robots to conduct a scan of the wheel using scanning hardware such as a laser scanner, an optical imager and/or a 3 dimensional camera so that the control system has spatial data relating to the wheel and to the individual positions of each of the nuts. The robot control system then causes the robots 13 and 14 to run through a sequence in which they position the nut runners on each of the nuts and operate the nut runner 61 so as to remove nuts holding the wheel onto the truck, as shown for example in FIGS. 22 to 25. Captive washers are preferably used to minimise the additional complexity that separate washers would cause. As each nut is removed, the robot control system causes the robot to deposit the nut in a set position within a magazine for later retrieval. Once all of the nuts are removed, the tyre handler 4 is used to remove the wheel 3 from the truck.

One of the important functions of a tyre handler 4 is to rotate and then refit tyres so that the previous outer edge of the tyre becomes the new inner edge. This promotes even tread wear on the tyres. Hence, the robots 13 and 14 each have a rest position that provides sufficient clearance to allow for the removed tyre and wheel to be rotated within the grab unit without hitting either of the robots.

A reversal of the steps described above may be undertaken to fit a wheel onto the truck. When fitting a wheel to a truck, the robot control system is programmed to drive the robots 13 and 14 to perform the nut tightening in a sequence that aims to spread the load approximately equally across all of the nuts. Some embodiments of the nut runners provide for data logging of the final torque level to which each of the nuts has been tightened, which may be advantageous for the purposes of maintaining a safety audit trail and for quality assurance purposes.

Other examples of tools that the robots are capable of operating include an o-ring installation device, a cleaning device, a tyre inflation device and a tyre deflation device. The various tools as required for a particular job may be stored in locations on the fork truck part of the tyre handler 4.

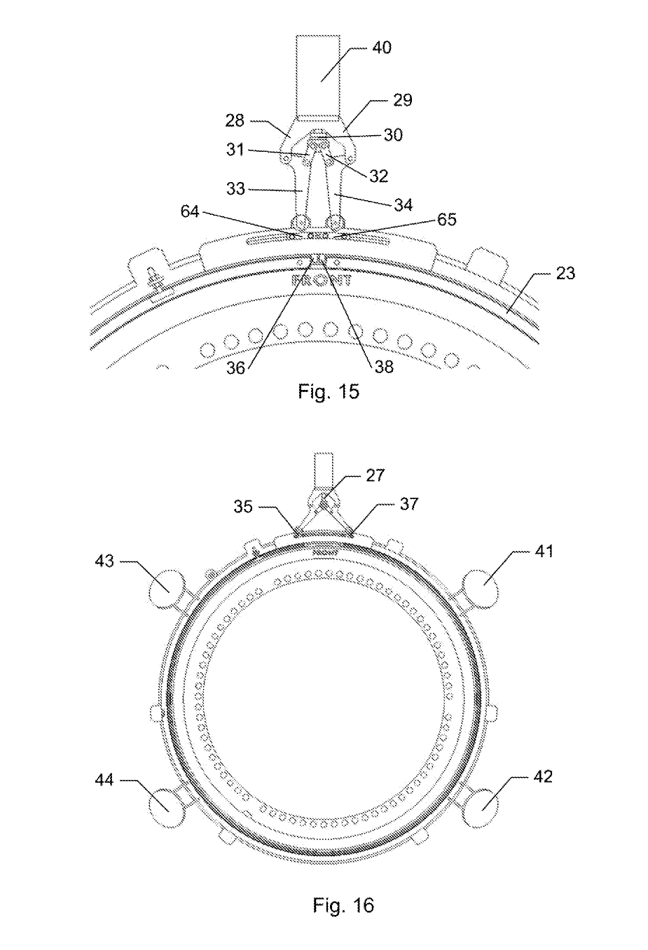

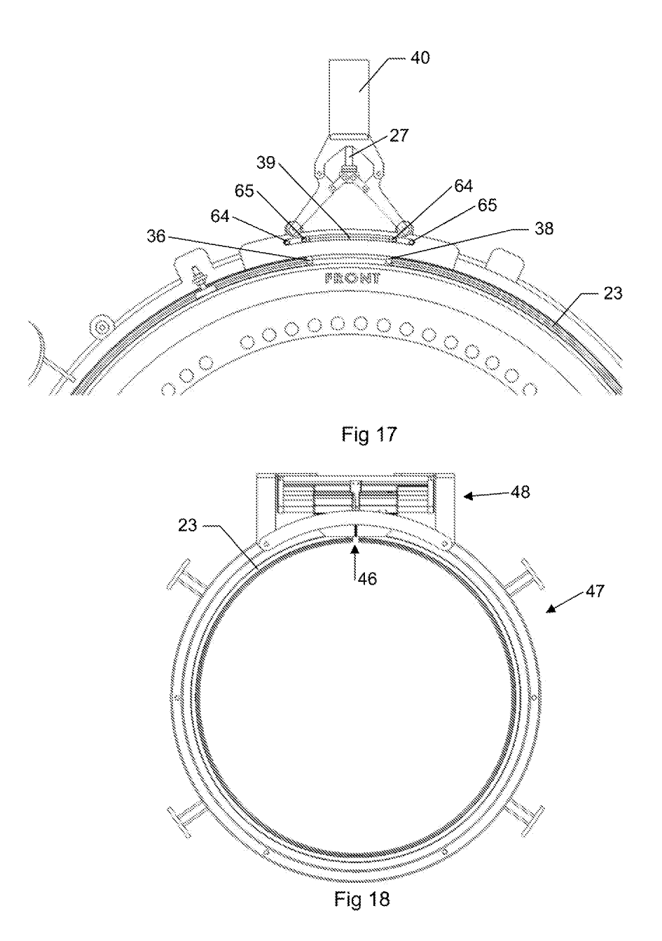

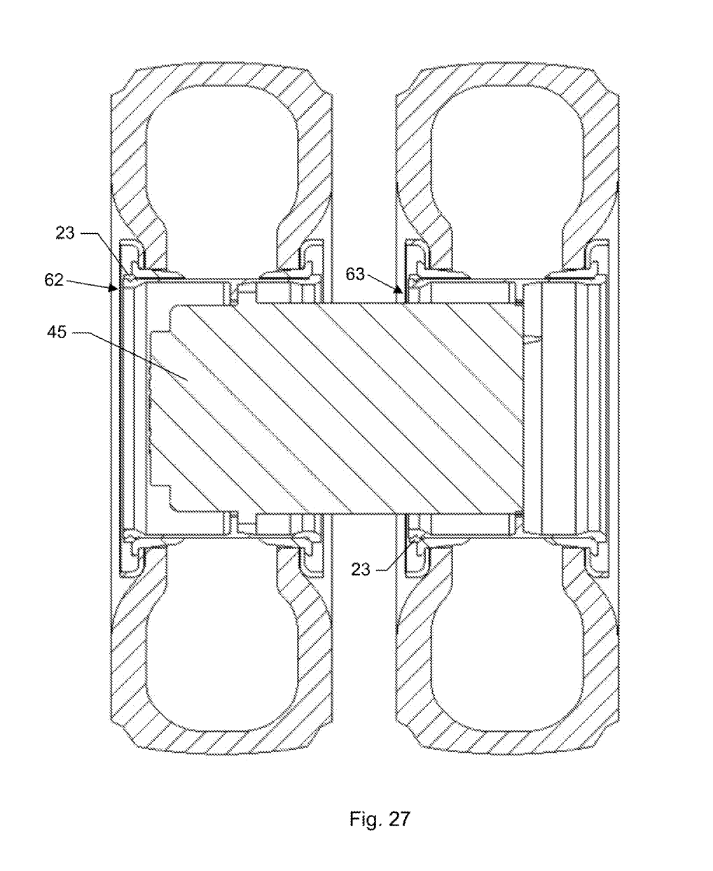

A first embodiment of a lock ring gap spreader 20 is illustrated in FIGS. 14 to 17. It is used to remove and install the circular clips, referred to as “lock rings”, within a circumferential slot 21 in the wheel rim 22. Lock rings 23 are used to retain the tyre bead 24 in the desired position upon the wheel rim 22. An exploded view of a wheel rim 22 and associated jewelry, including a lock ring 23, is depicted in FIG. 26. A cross sectional view of a dual rear wheel assembly is depicted in FIG. 27. The lock ring gap spreader 20 includes a circular housing 25 that has an internal diameter that is slightly greater than the external diameter of the lock ring 23 to allow it to be fitted around the lock ring 23.

Four handles 41, 42, 43 and 44 are disposed equidistantly along the circumference of the housing 25. Each of the handles is for engagement by one of the robotic arms 13 or 14. This allows the robot to physically handle the lock ring gap spreader 20 and includes an electrical interface to enable control signals to be provided from the robot 13 or 14 to operate the lock ring gap spreader 20.

An automated spreader unit 26 is disposed on a periphery of the housing 25. It has a hydraulic or pneumatic cylinder 40 that forces a rod to radially extend or retract from the cylinder in accordance with a control signal that is provided to the cylinder by the robot control system. In an alternative embodiment a linear electric actuator takes the place of the hydraulic or pneumatic cylinder 40. The cylinder 40 is rigidly connected to left and right outer arms 28 and 29. The left outer arm 28 is hingedly connected to a minor extremity of left L-shaped member 33. The distal end of the rod 27 is rigidly connected to a boss 30. A left inner arm 31 is hingedly connected at a proximal end to the left hand side of the boss 30 and at a distal end to the apex of the left L-shaped member 33. The major extremity of the left L-shaped member 33 is hingedly attached to a left hand circumferential slider unit 35, which is rigidly connected to a left hand projection 36.

The right outer arm 29 is hingedly connected to a minor extremity of right L-shaped member 34. A right inner arm 32 is hingedly connected at a proximal end to the right hand side of the boss 30 and at a distal end to the apex of the right L-shaped member 34. The major extremity of the right L-shaped member 34 is hingedly attached to a right hand circumferential slider unit 37, which is rigidly connected to a right hand projection 38.

Each of the circumferential slider units 35 and 37 has a pair of followers 64 and 65, which track within a circumferential slot 39. The geometry of this arrangement is such that, when the rod 27 is retracted within the cylinder 40, the spreader unit 26 is in a closed state in which in the left and right projections 36 and 38 are disposed close enough to each other so as to fit within a gap 46 in the installed lock ring 23. However, as the rod 27 extends from the cylinder 40, the slider units 35 and 37 are forced by the L-shaped arms 33 and 34 to slide apart. This causes the spreader unit 26 to assume its open state whereby the left and right projections 36 and 38 are circumferentially spaced apart from each other.

The method of removing the lock ring 23 from a slot 21 in a wheel rim 22 commences with the use of the tyre handler 4 to displace the outer bead of the tyre 24 away from the lock ring 23. This provides some clearance between the lock ring 23 as installed on the wheel rim and the other jewelry that is depicted in FIG. 26 so as to improve access to the lock ring 23. Next the pair of robots 13 and 14 conduct a scan of the wheel 3 and hub 45 using a scanner such as any one or more of: an optical imager; a laser scanner; and/or a 3 dimensional camera. This provides the robot control system with spatial information from which the control system may determine the positioning of the gap 46 in the lock ring 23 (which may be in any position around the circumference of the slot 21). Then the pair of robots 13 and 14 grasp the lock ring gap spreader 20 using two of the four available handles 41, 42, 43 or 44, as shown for example in FIG. 2. The control system sends a signal via one of the robots 13 or 14 to ensure that the spreader unit is in the closed state. Then the control system drives the two robots 13 and 14 so as to work cooperatively to position the lock ring gap spreader 20 in axial alignment with the hub 45, as shown for example in FIGS. 6 to 8.

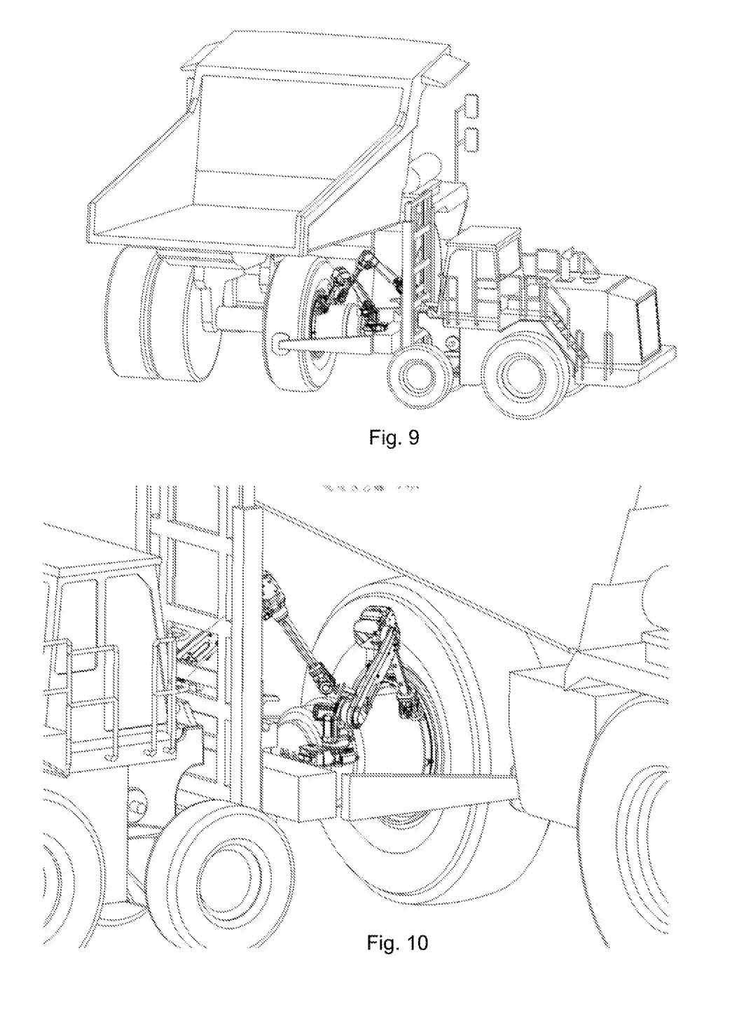

The control system then causes the two robots 13 and 14 to rotate the lock ring gap spreader 20 until the projections 36 and 38 are in axial alignment with the previously determined position of the gap 46. This may require the two robots to conduct a hand-to-hand shuffle of the handles 41, 42, 43 and 44 to achieve the desired alignment. The two robots 13 and 14 then displace the lock ring gap spreader 20 axially along the hub 45 until the housing 25 surrounds the installed lock ring 23, as shown for example in FIGS. 9 to 12. The two projections 36 and 38 of the spreader unit 26 are positioned within the gap 46. Then, the control system sends a signal via one of the robots 13 or 14 to instruct the spreader unit 26 to assume the open state. The rod 27 then extends from the cylinder 40 and this movement is transmitted via arms 28, 29, 31, 32, 33, 34 to drive the two circumferential slider units 35 and 37 apart. This, in turn, spreads the projections 36 and 38 circumferentially apart so as to spread the gap 46 in the lock ring 23 thereby freeing the lock ring 23 from the wheel rim 22.

Whilst the gap 46 in the lock ring 23 is spread apart, and once the lock ring is no longer seated within the slot 21 of the rim 22, there is a risk of the lock ring 23 twisting and springing off the projections, which could be potentially damaging and dangerous. For this reason, once the gap 46 is spread apart and the outer diameter of the lock ring 23 is thereby increased, the lock ring 23 is now sized to be received by, and retained within, the housing 25, which provides support to resist twisting and to stably retain the lock ring 23.

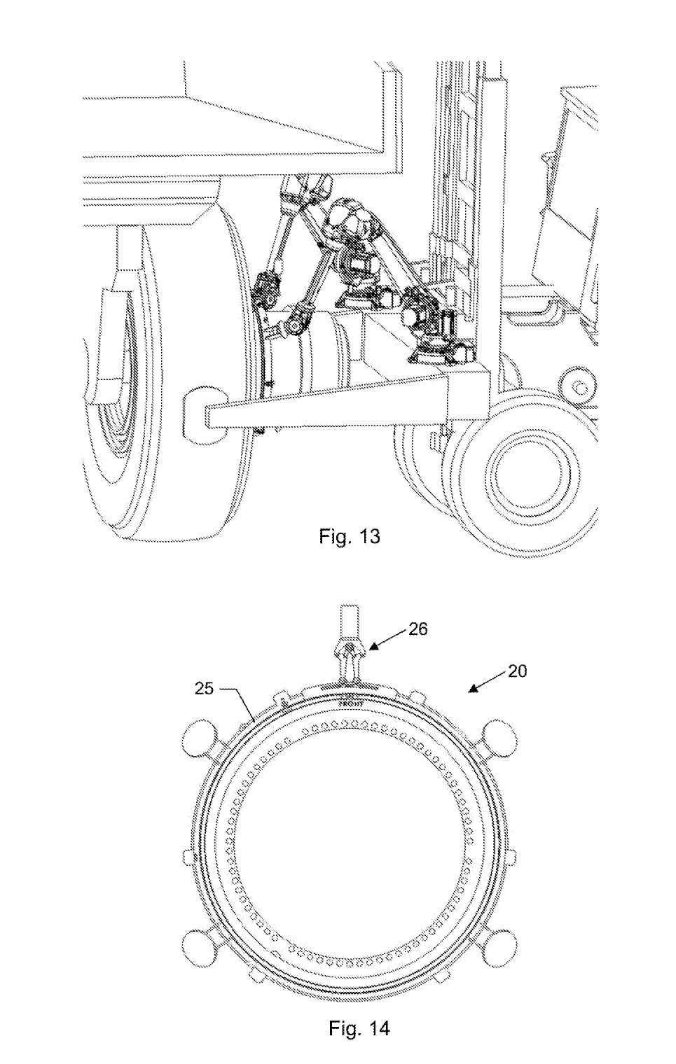

The control system then causes the two robots 13 and 14 to displace the lock ring gap spreader 20 (with the lock ring 23 housed within) axially away from the truck as shown in FIG. 13 until the lock ring gap spreader 20 is free of the hub 45. The lock ring 23 may then be moved by the tyre handler 4 to a desired position away from the truck and released from the lock ring gap spreader 20 by instructing the spreader unit to assume the closed state, which contracts the gap 46 and reduces the outer diameter of the lock ring 23, thereby freeing the lock ring 23 from the housing 25. The lock ring 23 has now been safely removed without requiring any manual labour within the danger region immediately adjacent the wheel.

Once the lock ring has been removed the tyre handler 4 may be used to break the rear bead and remove the tyre 2 from the wheel 3. It is then typically necessary to remove the used o-ring 55 from the wheel rim 22. This may be performed manually or by the robots 13 and 14. Typically the used o-ring 55 is discarded and hence it may simply be destroyed whist being removed, for example by being ripped off.

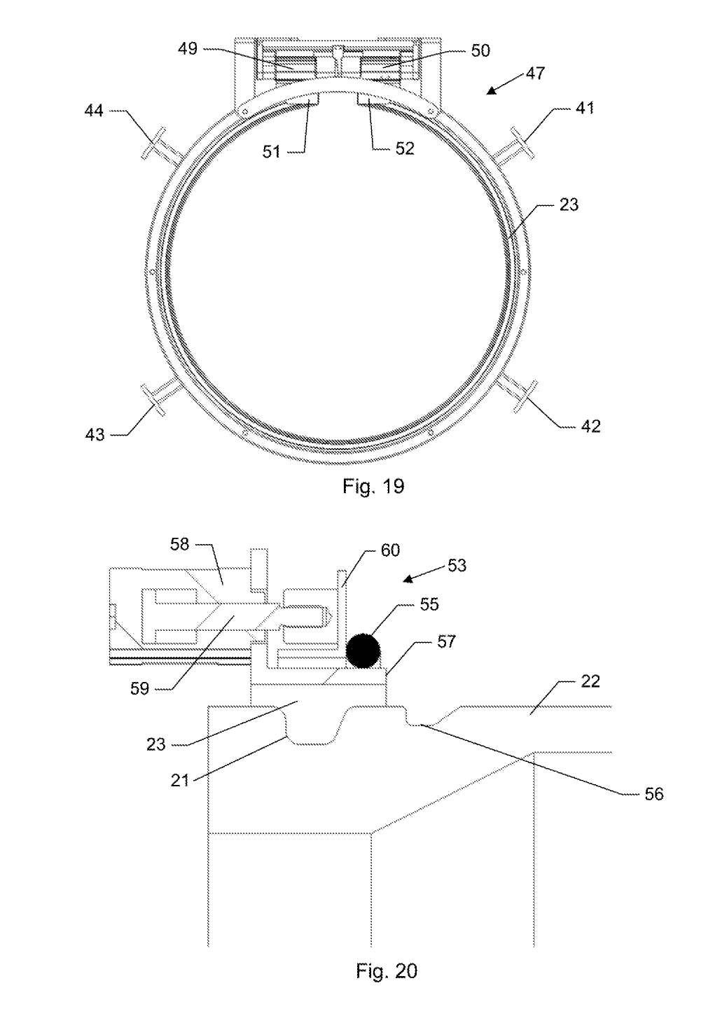

An alternative embodiment of a lock ring gap spreader 47 is shown in a closed state in FIG. 18 and in an open state in FIG. 19. It functions identically to that described above for the first embodiment, except a different spreader unit 48 is utilized in which two hydraulic or pneumatic cylinders 49 and 50 (or a pair of linear electric actuators) are positioned in axial alignment with each other, but with opposing directions of motion. Each of the cylinders 49 and 50 is respectively attached to an engagement assembly 51 and 52. When in the closed state, the two cylinders 49 and 50 position the engagement assemblies 51 and 52 in close enough proximity to each other to allow the engagement assemblies 51 and 52 to be positioned within the gap 46 of an installed lock ring 23. When in the open state the two cylinders 49 and 50 circumferentially spread the engagement assemblies 51 and 52 apart so as to free the lock ring 23 from the slot 21 in the wheel rim 22.

By reversing the steps outlined above, it is possible to use the lock ring gap spreader 20 or 47 to install a lock ring 23 onto the slot 21 that is provided in the wheel rim 22. More particularly, the method of installing the lock ring 23 onto the slot 21 in the wheel rim 22 commences with the robot control system sending a signal via one the robots 13 or 14 to put the lock ring gap spreader 20 or 47 into the closed state. Next the robot control system drives the robots 13 and 14 so as to position the pair of projections 36 and 38 within the gap 46. The robot control system then sends a signal to toggle the lock ring gap spreader 20 or 47 into the open state so as to spread the gap 46 and thereby expand the lock ring 23 such that it is housed within the housing 25. Next the robot control system drives the robots 13 and 14 so as to position the lock ring gap spreader 20 or 47 such that the housed lock ring 23 is radially aligned with the slot 21. The robot control system then sends a signal to toggle the lock ring gap spreader 20 or 47 into the closed state, which contracts the lock ring 23 such that it seats onto the slot 21.

In some embodiments, the robots 13 and 14 have access to dispensers, which may be operated by the robots to deliver materials and/or fluids as required during the fitment of the tyre 2. For example, in some circumstances it may be necessary to use the robots 13 and 14 to deliver a lubricant such as “rim soap” to assist in fitting the tyre onto the wheel. Alternatively, adhesives to bond the tyre bead 24 to the wheel rim 22 may be delivered. Additionally, it may be necessary to use the robots 13 and 14 to deliver fire retardant materials within the tyre 2 immediately prior to installing the tyre 2 onto the rim 22.

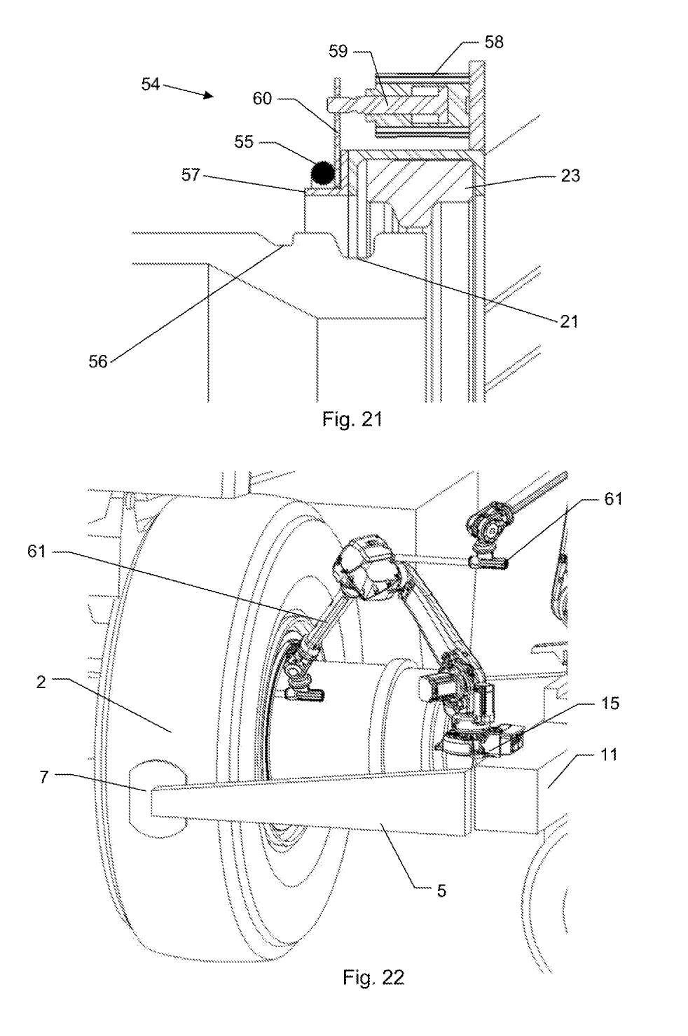

When fitting a tyre 2 to a wheel 3 it is typically necessary to install a fresh o-ring 55 into a slot 56 that is provided within the wheel rim 22. A cross sectional depiction of a first embodiment of an o-ring installation device 53 is shown in FIG. 20. A cross sectional depiction of a second embodiment of an o-ring installation device 54 is shown in FIG. 21. The main difference between the two embodiments is that the first embodiment is dedicated solely to o-ring installation; whereas the second embodiment fulfills the functions of o-ring installation and lock ring removal. Each of the embodiments of the o-ring installation device 53 and 54 include a circular ledge 57 sized for fitment around the wheel rim 22.

An electromagnetic linear actuator 58 is disposed on a periphery of the circular ledge 57. It will be appreciated that other types of actuator, such as hydraulic or pneumatic actuators, may be used in alternative embodiments, as required. The actuator 58 has a rod 59 that is depicted in FIGS. 20 and 21 as being in a retracted position; however in response to a control signal, the actuator can extend the rod 59. The rod 59 is connected to an elongate member 60 that is disposed at right angles to the ledge 57. In alternative embodiments the elongate member 60 may be disposed at other angles relative to the ledge 57, within a range of between about 45° to about 135°. Movement of the rod 59 causes the elongate member 60 to sweep across the ledge 57 and displace the o-ring off the edge of the ledge 57.

The o-ring 55 has a diameter that is slightly smaller than the slot 21 into which it is to be installed. Given that the circular ledge is sized for fitment around the wheel rim 22, it therefore follows that the o-ring diameter is also smaller than the diameter of the circular ledge 57. To commence the o-ring installation process, the o-ring 55 is firstly loaded onto the circular ledge 57. This requires a slight stretching of the o-ring when it is manually installed onto the circular ledge 57, which retains the o-ring 55 upon the circular ledge 57 by frictional engagement of the o-ring 55 with the ledge 57 due to the resiliency of the o-ring 55. That is, the resiliency of the o-ring 55 causes it to radially bear upon the ledge and it is preferably pushed along with ledge 57 so as to rest against the elongate member 60, as shown in FIGS. 20 and 21. This installation is done manually and may take place at a safe distance from the truck.

Once the o-ring 55 has been loaded onto the circular ledge 57, the o-ring installation device 53 is grasped by the two robots 13 and 14 via two of the four handles in a similar manner to that described above with regard to the lock ring gap spreader 20. The control system then drives the robots 13 and 14 to position the o-ring removal device 53 into axial alignment with the wheel rim 22. The control system then drives the robots 13 and 14 to axially displace the o-ring removal device 53 toward the slot 56 until the edge of the ledge 57 is adjacent the slot 56 as shown in FIGS. 20 and 21. The control system then sends, via one of the robots 13 or 14, a signal to the electromagnetic linear actuator 58. In response to the signal, the actuator extends the rod 59, which causes the elongate member 60 to sweep across the ledge 57 and thereby overcome the frictional engagement so as to displace the o-ring 55 off the ledge 57. The o-ring 55 is then free to radially contract so as to seat within the slot 56 in the wheel rim 22. The o-ring is now safely installed in the slot 56.

As shown in FIG. 27, the rear wheel assembly features two wheels, each of which has an o-ring 55. Once the both the outer wheel 62 and the inner wheel 63 have been removed, the reach of the two robots 13 and 14 is sufficient to thread the o-ring installation device 53 along the hub for installation of the inner o-ring 55 in addition to the outer o-ring 55.

Once a tyre 2 has been loosely fitted to a wheel 3, an embodiment of the invention includes an inflation device whereby a hose is connected at a proximal end to an air compressor that is stored on the fork truck part of the tyre handler. An outlet nozzle is disposed on the distal end of the hose. In this embodiment the control system drives one of the robots 13 to manipulate the distal end of the hose such that the outlet nozzle engages the wheel's inlet valve. The control system then sends a signal to the air compressor to start the provision of pressurized air to inflate the tyre. As inflation commences the other robot 14 operates an impulse hammer so as to seat the bead 24 of the tyre 2. Inflation then proceeds until the desired inflation pressure has been achieved within the tyre 2.

Embodiments of the present invention marry the robotics with the tyre handler 4 to provide a single functional unit. This compares favourably with the disclosure of WO 2012/094706 in which the robotics is disposed on a movable vehicle 42 that is separate from the tyre handler. Importantly, when disposed on the tyre handler, the robotic arms 13 and 14 of the preferred embodiment of the present invention have good access to the wheel. This compares favourably with the disclosure of WO 2012/094706 in which the robotic arm is disposed on a moveable vehicle 42 that is located to the side of the arms of the separate tyre handler. This arrangement requires the robotic arm disclosed in WO 2012/094706 to work around the obstruction caused by the arms of the tyre handler. Additionally, the present invention allows the operator of the tyre handler to maintain an improved view of the working area, as compared to the disclosure of WO 2012/094706 in which the separate movable vehicle 42 may cause a visual obstruction. Further, the integration of robotics onto the currently used tyre handling equipment allows for minimal impact on current practices (other than to advantageously remove labour from the danger zone) and maintains the familiarity that operators have with known tyre handling equipment. It also allows the fork truck part of the tyre handler 4 to provide hydraulic, pneumatic and/or electrical services for the robotics that are disposed on the grab unit.

While a number of preferred embodiments have been described, it will be appreciated by persons skilled in the art that numerous variations and/or modifications may be made to the invention without departing from the spirit or scope of the invention as broadly described. The present embodiments are, therefore, to be considered in all respects as illustrative and not restrictive.

1. A tyre changing apparatus for use with a tyre disposed on a wheel, said apparatus including:
a tyre handler having two arms respectively defining distal ends adapted in use to clampingly engage the tyre; and
at least one robot disposed on said tyre handler, the at least one robot being positioned for interaction with the wheel when the tyre is clampingly engaged by said distal ends.

2. A tyre changing apparatus according to claim 1 wherein the two arms define respective proximal ends that are each disposed on a frame and wherein said at least one robot is disposed at, or adjacent to, at least one of the proximal ends.

3. A tyre changing apparatus according to claim 2 wherein a first robot is disposed at, or adjacent to, the proximal end of a first of the two arms and wherein a second robot is disposed at, or adjacent to, the proximal end of a second of the two arms.

4. A tyre changing apparatus according to claim 1 wherein the at least one robot is a robotic arm having a proximal end disposed on said tyre handler and having a distal end from which a tool is operable.

5. A tyre changing apparatus according to claim 4 wherein the tool is at least one of:
a nut runner; a lock ring gap spreader; an o-ring installation device; a cleaning device; an inflation device; or a deflation device.

6. A lock ring gap spreader for use with a lock ring defining a gap, the lock ring gap spreader including:
a circular housing sized for fitment around the lock ring; and
an automated spreader unit disposed on a periphery of the housing, the automated spreader unit acting upon a pair of projections so as to define a closed state in which the pair of projections are disposed close enough to each other so as to fit within the gap and said spreader unit defining an open state in which the pair of projections are circumferentially spaced from each other so as to spread the gap in the lock ring.

7. A lock ring gap spreader according to claim 6 wherein the automated spreader unit is hydraulic or pneumatic.

8. A lock ring gap spreader according to claim 6 further including a plurality of handles disposed on the periphery of the housing, each of the handles being engagable by a robotic arm.

9. A lock ring gap spreader according to claim 6 wherein the circular housing is sized so as to receive the lock ring whilst the gap in the lock ring is being maintained in a spread apart state by the spreader unit to thereby stablise the lock ring against twisting.

10. An o-ring installation device for installing an o-ring onto a slot in a wheel rim, the o-ring installation device including:
a circular ledge sized for fitment around the wheel rim and being sized so as to retain the o-ring upon the ledge by frictional engagement of the o-ring with the ledge; and
an actuator disposed on a periphery of the ledge and being operable to displace the o-ring off the ledge such that, in use, the o-ring radially contracts onto the slot in the wheel rim.

11. An o-ring installation device according to claim 10 wherein the actuator is an electromagnetic linear actuator.

12. An o-ring installation device according to claim 10 wherein the actuator acts upon an elongate member disposed at an angle of between 45° and 135° with respect to the ledge.

13. An o-ring installation device according to claim 12 wherein the o-ring is installable so as to resiliently radially bear upon the ledge and so as to rest against the elongate member.

14. A method of removing a wheel from a truck including the steps of:
providing a tyre changing apparatus according to claim 1;
using the tyre handler to clampingly engage a tyre on the wheel;
causing the robot to operate a nut runner so as to remove nuts holding the wheel onto the truck; and
using the tyre handler to remove the wheel from the truck.

15. A method of removing a lock ring from a slot in a wheel rim, the method including the steps of:
providing a tyre changing apparatus; for use with a tyre disposed on a wheel, said apparatus including a tyre handler having two arms respectively defining distal ends adapted in use to clampingly engage the tyre; and at least one robot disposed on said tyre handler, the at least one robot being positioned for interaction with the wheel when the tyre is clampingly engaged by said distal ends;
using the tyre handler to displace a bead of the tyre away from the lock ring installed on the wheel;
causing the robot to operate a lock ring gap spreader as defined in claim 6 so as to remove the lock ring.

16. A method of installing a lock ring onto a slot in a wheel rim, the method including the steps of:
causing a robot to operate a lock ring gap spreader as defined in claim 6 in the closed state so as to position the pair of projections within a gap in the lock ring;
toggling the lock ring gap spreader into the open state so as to spread the gap and so as to house the lock ring within the housing;
causing the robot to position the lock ring gap spreader such that the housed lock ring is radially aligned with the slot; and
toggling the lock ring gap spreader into the closed state so as to install the lock ring onto the slot.

17. A method of installing an o-ring onto a slot provided within a rim of a wheel, the method including the steps of:
providing a tyre changing apparatus; for use with a tyre disposed on a wheel, said apparatus including a tyre handler having two arms respectively defining distal ends adapted in use to clampingly engage the tyre; and at least one robot disposed on said tyre handler, the at least one robot being positioned for interaction with the wheel when the tyre is clampingly engaged by said distal ends; and
causing the robot to operate an o-ring installation device as defined in claim 10 so as to install the o-ring.
